(19) United States
(12) Patent Application Publication
(10) Pub. No.: US 2025/0251777 A1
(43) Pub. Date: Aug. 7, 2025

(54) POWER SEQUENCE CONTROL CIRCUIT

(71) Applicant: Google LLC, Mountain View, CA (US)

(72) Inventors: Yao DING, Mountain View, CA (US); Qi QI, Mountain View, CA (US)

(73) Assignee: Google LLC, Mountain View, CA (US)

(21) Appl. No.: 18/434,432

(22) Filed: Feb. 6, 2024

(51) Int. Cl. G06F 1/3296; G06F 1/30; G06F 1/3287

(52) U.S. Cl. CPC G06F 1/3296; G06F 1/305; G06F 1/3287

(57) ABSTRACT

A power sequence control circuit can include a global enable node and a first rail control circuit that has first resistor-capacitor (RC) characteristics. A first rail enable node is coupled to the first rail control circuit and a first voltage regulator. A second rail control circuit has different RC characteristics, and a second rail enable node is coupled to the second rail control circuit and a second voltage regulator. Turning on a global enable signal causes a first enable signal on the first rail enable node to be turned on before a second enable signal on the second rail enable node, causing the first voltage regulator to turn on before the second voltage regulator. Turning off the global enable signal causes the second enable signal to be turned off before the first enable signal, causing the second voltage regulator to turn off before the first voltage regulator.

### BACKGROUND

Electronic devices require specific power supply rails to power their components. Some electronic components require multiple power supply rails having different voltage levels, which can be provided by voltage regulators. There may also be specific requirements for the sequencing and/or timing of enabling and disabling those power rails. For example, some electronic components may have strict requirements that the power rails be turned on and turned off in a particular sequence and/or after particular time periods. In some cases, such sequencing can avoid potential issues such as latch-up condition from transient spikes in a power supply which may cause a malfunction or damage to electronic components.

Some devices use a power management integrated circuit (PMIC) to control power sequencing and timing of turning on and off of power supply rails. However, a PMIC may take up a large amount of area in a device and its use may not be feasible for many small devices, e.g., earbuds and other wearable devices.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations described herein relate to a power sequence control circuit. In some implementations, a power sequence control circuit includes a global enable node; a first rail control circuit coupled to the global enable node, the first rail control circuit having one or more first resistor-capacitor (RC) characteristics; a first rail enable node coupled to the first rail control circuit and to a first voltage regulator; a second rail control circuit coupled to the global enable node, the second rail control circuit having one or more second RC characteristics that are different than the one or more first RC characteristics; and a second rail enable node coupled to the second rail control circuit and to a second voltage regulator. Turning on a global enable signal on the global enable node causes a first enable signal on the first rail enable node to be turned on before a second enable signal on the second rail enable node is turned on, thereby causing the first voltage regulator to turn on before the second voltage regulator is turned on. Turning off the global enable signal on the global enable node causes the second enable signal on the second rail enable signal to be turned off before the first enable signal on the first rail enable node is turned off, thereby causing the second voltage regulator to turn off before the first voltage regulator is turned off.

Various features of the power sequence control circuit are disclosed. For example, in some implementations, the one or more first RC characteristics include a first power-on RC characteristic that is applied when the global enable signal is turned on, and a second power-off RC characteristic that is applied with the global enable signal is turned off, and the one or more second RC characteristics include a third power-on RC characteristic that is applied when the global enable signal is turned on, and a fourth power-off RC characteristic that is applied with the global enable signal is turned off. In some implementations, the first voltage regulator and the second voltage regulator are coupled to an electronic component on an integrated circuit and provide power to the electronic component. In some implementations, the first rail control circuit and the second rail control circuit are passive and do not require power to operate.

In some implementations, the first rail control circuit includes: a first resistor that has a first resistance value and is coupled between the global enable node and the first rail enable node; a second resistor that has a second resistance value and is coupled to the global enable node; a first diode coupled between the first second resistor and the first rail enable node; and a first capacitor coupled between the first rail enable node and a ground; and the second rail control circuit includes: a third resistor that has a third resistance value and is coupled between the global enable node and the second rail enable node; a fourth resistor that has a fourth resistance value and is coupled to the global enable node; a second diode coupled between the fourth resistor and the second enable signal; and a second capacitor coupled between the second rail enable signal and the ground. The first enable signal on the first rail enable node is turned on, based on a first power-on RC time constant of the first rail control circuit, before the second enable signal on the second rail enable node is turned on based on a second power-on RC time constant of the second rail control circuit; and the second enable signal on the second rail enable node is turned off, based on a second power-off RC time constant of the second rail control circuit, before the first enable signal on the first rail enable node is turned off based on a first power-off RC time constant of the first rail control circuit. In some implementations, the timing of the turning off of the first enable signal is based on the first resistance value in parallel with the second resistance value as the first diode conducts in response to the turning off of the global enable signal, and the timing of the turning off of the second enable signal is based on the third resistance value in parallel with the fourth resistance value as the second diode conducts in response to the turning off of the global enable signal. In some implementations, the first diode and the second diode are configured to conduct in a direction toward the global enable node, and in other implementations, these diodes are configured to conduct in a direction away from the global enable node.

In some implementations, the first rail control circuit includes: a connection between the global enable node and the first rail enable node; a first resistor that has a first resistance value and is coupled to the global enable node; a first diode coupled between the first resistor and the first rail enable node; and a first capacitor coupled between the first rail enable node and a ground; and the second rail control circuit includes: a second resistor that has a second resistance value and is coupled between the global enable node and the second rail enable node; a second diode coupled between global enable node and the second rail enable node; and a second capacitor coupled between the second rail enable node and the ground. The first enable signal on the first rail enable node is turned on, based on a first power-on RC time constant of the first rail control circuit, before the second enable signal on the second rail enable node is turned on based on a second power-on RC time constant of the second rail control circuit; and the second enable signal on the second rail enable node is turned off, based on a second power-off RC time constant of the second rail control circuit, before the first enable signal on the first rail enable node is turned off based on a first power-off RC time constant of the first rail control circuit. In some implementations, a resistance of the connection between the global enable node and the first rail enable node is lower than the second resistance value, and wherein a resistance of a connection between the global enable node and the second rail enable node via the second diode is lower than the first resistance value.

In some implementations, the first voltage regulator outputs a first operating voltage and the second voltage regulator outputs a second operating voltage, and the first operating voltage is lower than the second operating voltage. In some implementations, the circuit further includes a third rail control circuit coupled to the global enable node and having a third resistor-capacitor (RC) characteristic; and a third rail enable node coupled to the third rail control circuit, wherein a third voltage regulator is coupled to the third rail enable node, wherein turning on the global enable signal on the global enable node causes a third rail enable signal to be turned on after the first rail enable signal and the second rail enable signal are turned on, thereby causing the third voltage regulator to turn on after the first voltage regulator and the second voltage regulator are turned on, and wherein turning off the global enable signal on the global enable node causes the third rail enable signal to be turned off before the first rail enable signal and the second rail enable signal are turned off, thereby causing the third voltage regulator to turn off before the first voltage regulator and the second voltage regulator are turned off. In some implementations, the first voltage regulator outputs a first operating voltage, the second voltage regulator outputs a second operating voltage, and the third voltage regulator outputs a third operating voltage, where the first operating voltage is lower than the second operating voltage, and the second operating voltage is lower than the third operating voltage.

In some implementations, a power sequence control circuit includes a global enable node; a first rail enable node coupled to the global enable node and to a first voltage regulator; a rail control circuit coupled to the global enable node, the rail control circuit having a resistor-capacitor (RC) characteristic; and a second rail enable node coupled to the rail control circuit and to a second voltage regulator. Turning on a global enable signal on the global enable node causes a first enable signal on the first rail enable node to be turned on before a second enable signal on the second rail enable node is turned on, thereby causing the first voltage regulator to turn on before the second voltage regulator in turned on. Turning off the global enable signal on the global enable node causes the second enable signal on the second rail enable signal to be turned off before the first enable signal on the first rail enable node is turned off, thereby causing the second voltage regulator to turn off before the first voltage regulator is turned off.

### BRIEF DESCRIPTION OF THE DRAWINGS

FIG. 1 is a diagrammatic illustration of a graph showing example sequencing and timing requirements for power supply voltages, according to some implementations.

FIG. 2 is a block diagram illustrating an example system that can include a power sequence control circuit described herein, according to some implementations.

FIG. 3 is a schematic illustration of an example power sequence control circuit, according to some implementations.

FIG. 4 is a schematic illustration of another example power sequence control circuit, according to some implementations.

### DETAILED DESCRIPTION

This disclosure relates to a power sequence control circuit that can control the turning on and off of power supply voltages according to particular sequencing and timing requirements. In some implementations, a power sequence control circuit can include multiple rail control circuits that are connected to a global enable signal. Each rail control circuit is coupled to a respective rail enable node that is connected to a respective voltage regulator that provides a respective power rail voltage to an electronic component. Each rail control circuit has different resistor-capacitor (RC) characteristics, which provide different timing of the enable signals when the global enable signal is turned on or off. For example, when turning on the global enable signal, a first enable signal on the first rail enable node is turned on before a second enable signal on the second rail enable node is turned on, thereby causing the first voltage regulator to turn on before the second voltage regulator is turned on. Similarly, when turning off the global enable signal, the second enable signal is turned off before the first enable signal is turned off, thereby causing the second voltage regulator to turn off before the first voltage regulator is turned off.

Various implementations of the power sequence control circuit are described. For example, the rail control circuits can each include one or more resistors and capacitors having different values, thus providing different RC time constants in each circuit that provide different delays for the turning on and turning off of the enable signals and power rails. The values of the resistors and capacitors can be selected to provide any timing of the enable signals, e.g., to fit particular sequencing and timing requirements. In some implementations, each rail control circuit can include resistors configured in parallel, with one resistor in series with a diode, thus providing different respective resistance values for turning on and turning off of the enable signal.

Described features advantageously provide a compact and low cost solution for sequencing and timing the turning on and off of power supply rails for an electronic component. Circuits described herein can be very compact since they use a small number of passive components with low area requirements. These passive components are also low cost compared to an integrated circuit and do not require their own power supply. Furthermore, the components of the circuits described herein can be easily selected or changed to have particular values such that any timing and sequencing requirements can be met with requiring extensive procedures such as programming an integrated circuit. Furthermore, described circuits can be configurable to control any number of power supply rails.

Technical advantages of described features thus include a reduction of required area for a power sequencing control circuit on a device and reduction in consumption of power resources on a device, which may be significant for small portable devices operating with batteries or other limited power supply.

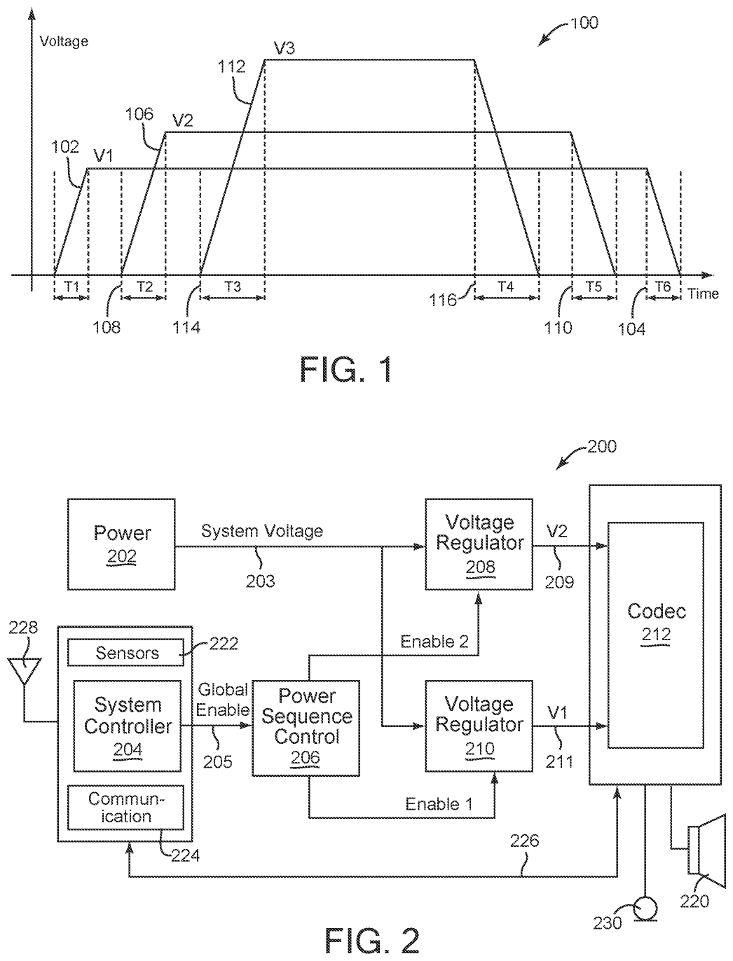

FIG. 1 illustrates a graph 100 showing example sequencing and timing requirements for power supply voltages, according to some implementations. Graph 100 shows example requirements for an electronic component that uses multiple power supply voltage rails and requires particular power rails to be enabled and disabled in specific sequences within particular time periods of each other. The graph shows a sequence of powering up (turning on) of voltage rail signals to an operating level, followed by a sequence of powering down (turning off) the voltage rail signals to zero.

A voltage rail signal 102 starts at zero voltage at an initial time and turns on to rise to a maximum or operating voltage level V1 over a time period T1. Voltage rail signal 102 stays at the operating voltage level V1 until the powered component is to be powered down at time 104. At this time, the signal 102 turns off (discharges) to the zero voltage over a time period T6. The turning off is required to begin after a voltage rail signal 112 has powered down to zero over a time period T4 and after a voltage rail signal 106 has powered down to zero over a time period T5.

Voltage rail signal 106 starts at zero voltage and turns on starting at a time 108 to power up to a maximum or operating voltage level V2 over a time period T2. The rise of signal 106 is required to begin after the voltage rail signal 102 is at its operating level (e.g., after the end of time period T1). Voltage rail signal 106 stays at the maximum voltage level V2 until the device is to be powered down. At a time 110, the signal 106 starts powering down to zero voltage over a time period T5. The powering down of signal 106 is required to begin after a voltage rail signal 112 has powered down to zero over a time period T4, and the powering down of signal 106 is required to end before time 104 when the voltage rail signal 102 starts powering down.

Voltage rail signal 112 starts at zero voltage and rises starting at a time 114 to power up to a maximum or operating voltage level V3 over a time period T3. The rise of signal 112 is required to begin after the voltage rail signal 102 is at operating level of V1 (after the end of time period T1) and after the voltage rail signal 106 is at operating level of V2 (after the end of time period T2). Voltage rail signal 112 stays at the operating voltage level V3 until the device is to be powered down. At a time 116, the signal 112 starts powering down to zero voltage over a time period T4. The powering down of signal 112 is required to end before voltage rail signal 106 has powered down to zero over a time period T5 and before voltage rail signal 102 has powered down to zero over a time period T6.

The example graph 100 indicates that, in these requirements, the lower the operating (or maximum) voltage of the signal, the earlier in the sequence the voltage is to be powered up and the later in the sequence the voltage should be powered down. In some implementations, a particular minimum amount of time is required to elapse after a previous signal settles to the operating or zero voltage level, before the next voltage rail signal in the sequence is powered up or down. In some examples, voltage rail signal 112 can be required to start powering up (at time 114) within 100 milliseconds after voltage rail signal 102 has finished powering up (or alternatively, 100 milliseconds after signal 102 has started powering up).

In some implementations, two power supply rails (e.g., voltage rail signals) can be used. For example, the V2 voltage can be omitted in graph 100, and timing requirements between signals can be adjusted (e.g., minimum time periods can be required between powering up and down of voltage rail signals 102 and 112). In some example implementations, the lower voltage power supply rail can be provided as a core rail that supplies power to main components of an electronic component and the higher voltage power supply rail can be provided as a peripheral rail that supplies power to other components of the device. In some implementations, more than three power supply rails may be used.

FIG. 2 is a block diagram illustrating an example system 200 that can include a power sequence control circuit described herein, according to some implementations. System 200 can be included in a device that uses two or more power supply rails that provide different supply voltages. In some examples, system 200 can be included in small portable or wearable devices such as earbuds, headphones, smartwatches, smartphones, eye-worn devices (e.g., augmented reality, virtual reality, or extended reality glasses; or other types of smart glasses), other wrist-worn or hand-worn devices (e.g., a ring worn on one or more fingers, a fitness band or other device worn on the wrist), etc.

System 200 includes a power supply 202 (power 202), system controller 204, power sequence control circuit 206, voltage regulator 208, voltage regulator 210, and an electronic component is coupled to power supply rails, which is shown as codec 212 in the example of FIG. 2. In some implementations, codec 212 may be a dedicated hardware element that is configured to perform media encoding and decoding operations, e.g., audio or video encoding/decoding. In some examples, system 200 can be implemented in a device that uses multiple power supply rails. For example, the device can be a computer device, including portable devices and wearable devices. In other implementations, codec 212 can be any other component that requires multiple power supply rails.

Power supply 202 provides power to system 200, e.g., a system voltage usable by codec 212. In some implementations, power supply 202 includes one or more batteries to provide the system voltage, and/or can be or include a different type of power supply. In FIG. 2, system voltage 203 can be output by power supply 202.

System controller 204 can include any processor (e.g., processing circuitry or integrated circuit) or other control circuit that controls operations of the device in which system 200 is included. In some examples, system controller 204 can include a system on a chip (SOC) that includes one or more processors, e.g., microprocessors or other processing circuitry. In some examples, system controller 204 may be a control circuit.

System controller 204 outputs a global enable signal 205 that is used to enable codec 212 for operation. For example, system controller 204 may determine that codec 212 is to be powered up or powered down based on one or more events or conditions that occur relative to the device in which system 200 is included.

In some implementations, one or more sensors 222 can be included in system 220 and are in communication with system controller 204. Sensors 222 can include any of a variety of types of sensors, e.g., optical sensors, capacitive sensors, motion sensors, etc. In some examples, if the device is earbuds or headphones that output sound to a user (e.g., using an output component of the device such as speaker(s) 220), the device may have been picked up by the user as sensed by motion sensors 222 of the device (e.g., accelerometers and/or gyroscopes). In further examples, capacitive sensors 222 can detect contact of the device by a user which may indicate imminent use of the device by the user. In further examples, optical sensors 222 can detect the presence of a user, which may indicate imminent use of the device by the user. If imminent use of the device is detected, the system controller 204 determines that codec 212 should be powered on for use in outputting audio to the user, and the system controller 204 outputs a global enable signal that provides an indication to power on components of system 200 including codec 212. In some examples, the global enable signal to power on components can be turned on and/or provided as a HIGH signal (a first voltage value).

In another example, the motion sensors 222 of the device may not detect motion of the device, e.g., after a threshold amount of time after the device has been placed to rest on a surface such as a table, desk, etc. by the user, and/or capacitive, optical, and/or other sensors 222 may not detect user presence, which may indicate that the device is no longer being used by the user. In such a case, the system controller 204 determines that codec 212 is to be powered down, and the controller 204 changes the state of the global enable signal to indicate to power down the components of system 200, e.g., the global enable signal can be turned off and/or provided as a LOW signal (a second voltage value that is lower than the voltage of the HIGH signal). Other voltage values (or reversed values) can be used instead of HIGH and LOW signals for the global enable signal in some implementations.

In some implementations, system controller 204 can also be in communication with a communication module 224, which can be used to communicate with other components of the device including codec 212 via bus 226. In some implementations, communication module 224 can be connected to an antenna 228 that can be used to receive signals from other devices. For example, wireless data can be received by antenna 228 and can be provided to codec 212, converted into audio signals, and output via speaker 220 as sound. In another example, wireless signals output by another device to check the status of the device of system 200 can be received by antenna 228 and/or wireless response signals can be output by antenna 228 to the other device.

Power sequence control circuit 206 receives global enable signal 205 from system controller 204 and controls multiple output enable signals to enable or disable power supply rail voltages to codec 212. Power sequence control circuit 206 provides a timing of its output enable signals to meet particular requirements in the sequence and timing of powering up and/or powering down particular power rails to the codec 212. For example, power sequence control circuit 206 can output enable signals Enable 1 and Enable 2 to different respective voltage regulators 208 and 210. The timing of the high and low states of these enable signals is such that it causes a sequencing of the turning on and turning off of the voltage regulators, and their supply voltage outputs, to follow timing and sequencing requirements of the codec 212. An example of such requirements is shown as the voltage rail signals shown in FIG. 1 (e.g., voltage rail signals 102 and 112).

In some implementations, power sequence control circuit 206 can output additional enable signals that are provided to additional voltage regulators. For example, an Enable 3 signal can be output to a third voltage regulator (not shown) that turns on and turns off the third voltage regulator to control the timing of the voltage output of that third regulator (e.g., to follow the voltage rail signal 106 of FIG. 1).

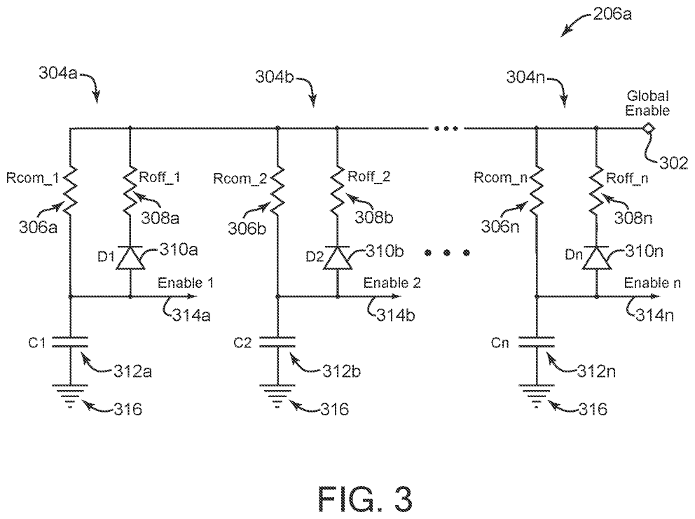

Some example implementations of power sequence control circuit 206 are described below with reference to FIG. 3.

Voltage regulator 208 and voltage regulator 210 receive system voltage 203 from power supply 202 and convert the voltage to regulated voltage outputs. For example, voltage regulator 208 can output a supply voltage rail 209 that has a voltage V2 and voltage regulator 210 can output a supply voltage rail 211 that has a voltage V1.

In some example implementations, one or more of the voltage regulators, such as voltage regulator 208, can be Low Drop-out (LDO) regulators. In some implementations, one or more of the voltage regulators, such as voltage regulator 210, can be Dynamic Voltage Frequency Scaling (DVFS) Switching Mode Power Supply (SMPS) regulators. For example, V1 of supply voltage rail 211 can be a lower voltage than V2 of supply voltage rail 209 and can be provided to components of codec 212 that consume more power than other components supplied by voltage rail signal 209; for example, supply voltage rail 211 can be used as a core voltage rail for codec 212 and supply voltage rail 209 can be used as a peripheral rail for codec 212.

In some of these implementations, a DVFS type regulator can be used as voltage regulator 210 to provide a core rail for codec 212, since it has higher efficiency than LDO regulators and thus greater power savings and thermal dissipation, and the output voltage of the regulator can be changed based on the current performance requirements of the codec 212. In some of these implementations, the LDO type of regulator can be used as voltage regulator 208 to provide a peripheral voltage rail for codec 212, since efficiency may not be as important and/or power requirements do not change as fast for the peripheral components. In various implementations, all voltage regulators 208, 210, etc. can be DVFS regulators, LDO regulators, or a mix of both types of voltage regulators. Other types of voltage regulators can alternatively be used.

In some example implementations, supply voltage rail 211 (V1) can provide voltage rail signal 102 of FIG. 1, and supply voltage 209 (V2) can provide voltage rail signal 112 of FIG. 1 (and voltage rail signal 106 of FIG. 1 is not used). In some implementations, supply voltage rails 209 and 211 can provide other voltage rail signals of FIG. 1, e.g., signals 102 and 106, or signals 106 and 112. In some implementations, additional voltage regulators can be similarly coupled to power sequence control circuit 206, e.g., a third voltage regulator that receives an Enable 3 signal from the power sequence control circuit 206 and outputs a supply voltage V3 to codec 212 or other component.

Voltage regulators 208 and 210 also receive Enable 2 and Enable 1 signals, respectively, from power sequence control circuit 206, that can turn on or turn off the regulators as described above, thus turning on or turning off their output supply voltage rails.

Codec 212 may receive supply voltage rail 209 and supply voltage rail 211 as power supply rails for its operation. In some examples, one of the supply voltage rails is used as a core voltage rail for the main processing of the codec 212, and the other supply voltage rail is used as a peripheral voltage rail for other functions or operations, e.g., input/output (I/O) operations. In some examples, supply voltage rail 211 provides the core voltage level of V1 and supply voltage rail 209 provides a peripheral voltage level of V2. In some implementations, when supply voltage rails 209 and 211 are disabled, codec 212 may power down, thus reducing power consumption of system 200.

Codec 212 can have particular timing requirements for the turning on and turning off of its power rail voltages. For example, the core power rail can be required to be turned on first, followed by the peripheral power rail, and the peripheral power rail can be required to be turned off first, followed by the core power rail. In some example cases, if these power rail timing sequence requirements are not met, malfunction or damage to the codec may occur. For example, a latch-up condition may occur in which a malfunction or a breakdown of an internal junction of the hardware of codec 212 may occur. Other types of powered components or integrated circuits may have similar timing requirements for multiple power rail voltages used by those components.

In some example implementations, codec 212 can perform operations for the device in which system 200 is included. For example, codec 212 can encode output signals (such as audio signals) and can decode input signals (such as voice or other audio signals) for operations such as noise cancellation in the output signals. For example, one or more speakers 220 can be connected to codec 212 and can receive signals output by the codec, and these signals can be converted to audio waves output by speaker 220. In some implementations, a microphone 230 can sense voice or other audio and provide corresponding signals to codec 212 and/or to system controller 204. For example, microphone 230 can sense voice or other audio in the environment of the device, and corresponding signals can be provided to codec 212 and/or system controller 204 (and/or other device components) for operations such as noise cancellation in signals output by the device. Other operations can also or alternatively be performed by codec 212.

In some implementations, other types of electronic components can be used in place of codec 212 that have other types of processing and operations to implement different features of the device that includes codec 212. Any processing component of a device that uses multiple different power supply rails can be used with features described herein.

FIG. 3 is a schematic illustration of an example power sequence control circuit 206a, according to some implementations. Control circuit 206a provides enable signals that can be used to turn on and off supply voltage rails provided to target electronic component(s) according to particular sequencing and/or timing requirements. In some examples, power sequence control circuit 206a can be, or can be included in, power sequence control circuit 206 of system 200 of FIG. 2, and can be used to control the power rail voltages provided to a target electronic component such as codec 212 in the example of FIG. 2 or other type of electronic component. In this description, a general reference number such as “304” refers generically to any or all components or elements having reference numbers that include the general reference number. A more specific reference number that includes the general reference number, such as “304a,” refers to a specific component or element.

Control circuit 206a includes a global enable node 302 that can receive a global enable signal. This node can be coupled to a controller of a device (e.g., system controller 204 of device 200) and receive the global enable signal from the controller. For example, the global enable signal can be high or low to control whether power is to be supplied or not on the controlled power rails to the target electronic component. For example, global enable node 302 can receive global enable signal 205 of FIG. 2.

Control circuit 206a includes multiple rail control circuits 304, where each rail control circuit 304 provides a respective power rail enable signal to a respective voltage regulator (or other component) to control a supply voltage output by that regulator. In this example, rail control circuit 304a provides one power rail enable signal Enable 1, rail control circuit 304b provides a different power rail enable signal Enable 2, and so on, e.g., rail control circuit 304n controls an nth power rail enable signal Enable n.

In some implementations, e.g., a general case, each rail control circuit 304 can include a common resistor 306, a power-off resistor 308, a diode 310, and a capacitor 312. Common resistor 306 has a resistance value Rcom and is coupled between global enable node 302 and a rail enable node 314 that provides the output rail enable signal of the rail control circuit 304. Power-off resistor 308 has a resistance value Roff and is coupled to the global enable node. Diode 310 is coupled between the power-off resistor 308 and the rail enable node 314. Diode 310 has a forward conducting direction from the rail enable node 314 toward power-off resistor 308 and global enable node 302. In some implementations, diode 310 can be a Schottky diode to provide a lower dropout, e.g., for particular types of voltage regulators that are being controlled. Capacitor 312 is coupled between rail enable node 314 and electrical ground 316.

Multiple rail control circuits 304 are shown in FIG. 3 that have this configuration. For example, rail control circuit 304a includes common resistor 306a, power-off resistor 308a, diode 310a, capacitor 312a, and rail enable node 314a that provides rail enable signal Enable 1. Similarly, rail control circuit 304b includes common resistor 306b, power-off resistor 308b, diode 310b, capacitor 312b, and rail enable node 314b that provides rail enable signal Enable 2. Additional rail control circuits 304 can also be provided, e.g., up to a rail control circuit 304n that has similar components to rail control circuits 304a and 304b.

The rail enable nodes 314 are each coupled to an enable input of a different respective voltage supply component, such as a voltage regulator, that turns on and off a respective supply voltage rail based on the respective enable signal on the associated rail enable node 314. In some examples, referring to the example system 200 of FIG. 2, rail enable node 314a can be coupled to voltage regulator 210 to control the turning on and off of supply voltage rail 211 to codec 212, and rail enable node 314b can be coupled to voltage regulator 208 to control the turning on and off of supply voltage rail 209 to codec 212.

In operation, power sequence control circuit 206a turns the enable signals on and off with particular timing, e.g., based on particular timing requirements as described with reference to FIG. 1. The electrical components of the rail control circuits 304 are selected to have properties (e.g., as parameters) that cause the enable signals to be enabled and disabled according to particular timing and which can form particular sequences with respect to each other. In some implementations, each rail control circuit 304 has properties including a first RC characteristic when global enable signal 302 is turned on and a second RC characteristic when global enable signal 302 is turned off. Each control circuit 304 can have a different power-on RC characteristic and power-off RC characteristic than other control circuits 304 of circuit 206a. Common resistor 306 influences rail enable node 314 when the global enable signal on node 302 turns on and also when that signal turns off, such that the resistance of resistor 306 is common to both turn-on and turn-off scenarios. Power-off resistor 308 influences rail enable node 314 when the global enable signal on node 302 turns off.

In an example of power rail sequencing requirements, the power rail controlled by the enable signal Enable 1 is required to be turned on (e.g., charged to its operating voltage) before the power rail controlled by enable signal Enable 2 is turned on. Furthermore, the power rail controlled by enable signal Enable 2 is required to be turned off (e.g., discharged to zero) before the power rail controlled by enable signal Enable 1 is turned off. For example, with reference to the example of voltage signal timing requirements shown in FIG. 1, enable signal Enable 1 can be connected to a first voltage regulator that provides voltage rail signal 102 as shown in FIG. 1, and thus can turn on and turn off the first voltage regulator; and enable signal Enable 2 can be connected to a second voltage regulator that provides voltage rail signal 112 as shown in FIG. 1, and thus can turn on and turn off the second voltage regulator. Other timing and/or sequencing requirements for the turning on and off of enable signals and power rail voltages can be used in other examples.

The properties of the resistors 306 and 308 (resistance values) and/or the capacitor 312 (capacitance value) are selected to obtain the required timing of the enable signals at rail enable nodes 314. Each rail control circuit 304 can be independently configured to turn on at a first particular time and to turn off at a second (different) particular time. For example, in each rail circuit 304, the resistance values of resistors 306 and 308 and capacitance of capacitor 312 are selected to provide a respective RC characteristic such as an RC time constant (product of the resistance and capacitance in the circuit 304) that provides a particular timing delay for charge (turning on) or discharge (turning off) of the voltage at rail enable node 314.

For example, the amount of time for an enable signal to charge up to a particular voltage level (e.g., a voltage level sufficiently high to provide an enable signal to a voltage regulator) is based on the delay provided by the RC time constant. Similarly, the amount of time for an enable signal to discharge to a particular voltage level (e.g., a voltage level sufficiently low to provide a disable signal to the voltage regulator) is based on the delay provided by the RC time constant. Thus, the RC time constant can be selected to provide a particular timing for the enable signal to reach particular voltage levels. In some implementations, in each rail control circuit 304, a different RC time constant may be provided for charging than for discharging the enable signal voltage of that circuit 304, allowing turn on and turn off times to be different for each enable signal. For example, such different RC time constants can be implemented by using diodes 310 as described below.

In an example of turning on supply voltages in response to the global enable signal being turned on, two rail control circuits 304a and 304b are used and the enable signal Enable 1 is to be turned on before the enable signal Enable 2. The RC time constant of control circuit 304a is made smaller than the RC time constant of control circuit 304b for current flowing from the global enable node 302 to the rail enable nodes 314a and 314b. The turn-on path in each circuit 304 is resistor 306 that charges capacitor 312.

In some examples, the RC time constant of rail control circuit 304a (based on the product of resistance Rcom_1 of resistor 306a and capacitance C1 of capacitor 312a) can be smaller than the RC time constant of rail control circuit 304b (based on the product of resistance Rcom_2 of resistor 306b and capacitance C2 of capacitor 312b). When the global enable signal 302 is turned on (enabled), diodes 310a and 310b do not conduct current, which prevents resistors 308a and 308b from contributing to the RC time constant. The smaller RC time constant of circuit 304a causes the delay for turning on the Enable 1 signal at the rail enable node 314a to be smaller than for turning on the Enable 2 signal at the rail enable node 314b, and thus, Enable 1 is turned on faster than Enable 2. This causes the regulated voltage controlled by the signal Enable 1 to be provided to the target electrical component before the other regulated voltage controlled by signal Enable 2 is provided to the target component. The resistance values of resistors 306a and 306b and the capacitance values of capacitors 312a and 312b can be selected such that the enable signals turn on at times that meet the power-on sequencing requirement (such as the example timing requirement for voltage rail signals 102 and 112 of FIG. 1).

In an example of turning off supply voltages, two rail control circuits 304a and 304b are used and the enable signal Enable 1 is to be turned off after the enable signal Enable 2 in response to the global enable signal being turned off. The turn-off path in each circuit 304 is resistor 306 in parallel with resistor 308 to discharge capacitor 312. In this example, the resistance values Rcom_1, Rcom_2, Roff_1, and Roff_2 and capacitance values C1 and C2 can be selected such that the RC time constant of rail control circuit 304b is smaller than the RC time constant of rail control circuit 304a for current flowing from the rail enable node 314 to the global enable node 302. For control circuit 304a, the RC time constant is the product of (Rcom_1∥Roff_1) (which is the parallel-connected resistance value of Rcom_1 and Roff_1) and the capacitance C1. For control circuit 304b, the RC time constant is the product of (Rcom_2∥Roff_2) (which is the parallel-connected resistance value of Rcom_2 and Roff_2) and the capacitance C2.

When the global enable signal 302 is turned off (disabled), diodes 310a and 310b conduct current, which allows the parallel resistance of resistors 306a/308a and 306b/308b to contribute to the RC time constant. The resistance of the RC time constant is based on the parallel configuration of resistors 306 and 308 (the parallel resistance is influenced by the resistor 308, unlike in the turn on case). Thus, when the RC time constant of rail control circuit 304b is smaller than the RC time constant for rail control circuit 304a, the delay for turning off the Enable 2 signal at the rail enable node 314b is smaller than the delay for turning off the Enable 1 signal at the rail enable node 314a, and Enable 2 is turned off faster than Enable 1. This causes the regulated voltage controlled by the signal Enable 2 to be turned off before the other regulated voltage controlled by signal Enable 1 is turned off, thus meeting the power-off sequencing requirement (such as the example timing requirement for voltage rail signals 102 and 112 of FIG. 1).

In some implementations, the resistance values and capacitance values are selected to obtain a faster turn-on time for Enable 1 than Enable 2 and to obtain a faster turn-off time for Enable 2 than Enable 1 based on the relationships described above. For example, if the capacitances C1 and C2 are the same for two circuits 304a and 304b (in some examples), for turning on the enable signals, the resistance value Rcom_1 of resistor 306a can be lower than the resistance value Rcom_2 of the resistor 306b. For turning off the enable signals, the parallel resistance Rcom_1∥Roff_1 of resistors 306a/308a can be higher than the parallel resistance Rcom_2∥Roff_2 of the resistors 306b/308b. In other examples, a different set of properties of the resistors 306, 308 and capacitor 312 can be used for each circuit to obtain RC time constants appropriate to the timing requirements.

In implementations that use more than two rail control circuits and enable signals (e.g., including rail control circuit 304n and Enable n), the properties of the resistors and/or capacitors in each circuit 304 can be similarly selected, relative to the properties of these components in each other circuit 304, to provide appropriate RC time constants to meet sequencing and/or timing requirements for the enable signals. For example, three rail control circuits 304a, 304b, and 304c may be used (e.g., circuit 304n can be 304c), where the enable signals are turned on and turned off with delay times that meet the timing requirements of the three voltage rail signals 102, 106, and 112 shown in the example of FIG. 1. For example, the enable signals can be powered up in a particular sequence of Enable 1 that controls voltage rail signal 102, Enable 2 that controls voltage rail signal 106, and Enable 3 that controls voltage rail signal 112, and then powered down in the reverse order of that sequence. In some examples, if the capacitance C1, C2, and C3 is the same for all three circuits 304 (in some examples), for turning on the enable signals, the resistance value Ron_1 can be the lowest resistance of the resistors 306a, 306b, and 306c, the resistance value Ron_2 can be the second lowest resistance of these resistors, and the resistance value Ron_3 can be the highest resistance of these resistors. For turning off the enable signals, the parallel resistance Roff_1∥Ron_1 can be the highest parallel resistance value of the parallel resistor pairs 308a/306a, 308b/306b, and 308c/306c, the parallel resistance value Roff_2∥Ron_2 can be the second highest parallel resistance value of these parallel resistor pairs, and the parallel resistance value Roff_3∥Ron_3 can be the lowest parallel resistance value of these parallel resistor pairs. In other examples, a different set of properties of the resistors 306, 308 and capacitor 312 can be used for each circuit to obtain RC time constants appropriate to the timing requirements.

In some implementations, one or more resistors and/or one or more capacitors of one or more rail control circuits 304 can be shorted connections, e.g., their properties (resistances or capacitances) set to zero or very small values. Different turn on and turn off timing (e.g., via different delays with different RC time constants) can still be provided for the different control circuits 304 in such implementations. For example, common resistor 306 of one of the rail control circuits 304 may have zero resistance (e.g., may be omitted such that there is a direct connection between node 314 of that rail control circuit and global enable node 302), which causes the enable signal at the associated rail enable node 314 to rise immediately at the same rate as the global enable signal 302. Such a resistor 306 (or omission of resistor 306) can be provided in a rail control circuit 304 that turns on a power rail before any other power rail being controlled by circuit 206a (e.g., resistor 306a in control circuit 304a in some examples above, that controls voltage rail signal 102 of FIG. 1).

In some implementations, the power-off resistor 308 of one of the rail control circuits 304 may have zero resistance (e.g., may be omitted such that there is a direct connection from diode 310 of that rail control circuit to global enable node 302). Resistor 308 having zero resistance can cause the associated rail enable node 314 to turn off immediately at the same rate as the global enable signal 302 through diode 310. For example, such a resistor 308 (or omission of resistor 308) can be provided in a rail control circuit 304 that turns off a power rail before any other power rail being controlled by circuit 206a (e.g., resistor 308b in control circuit 304b in some examples above, that controls voltage rail signal 112 of FIG. 1).

In some implementations, power-off resistor 308 of one of the rail control circuits 304 may have zero resistance (e.g., may be omitted similarly as above), but the associated rail enable node 314 can turn off at a delayed time, e.g., after one or more other rail control circuits 304 are turned off. For example, the voltage regulator controlled by the circuit 304 may be a DVFS voltage regulator (or other type of voltage regulator) that includes an internal delay timer that can delay the turning off and discharge of its supplied power, e.g., hold its supplied voltage for a particular period of time after its enable signal is turned off. This period of time can cause the associated power rail to be turned off after one or more other power rails are turned off. Other components that provide a delay timer can alternatively be used.

In some implementations, one of the rail control circuits 304 may have none of the resistor 306, resistor 308, and capacitor 312, thus providing a direct connection of the global enable signal 203 to the rail enable node 314 of that rail control circuit (the other rail control circuits can include one or more components, e.g., at least a resistor 306 and/or 308 and capacitor 312, to provide a different RC time constant). In some examples, such a direct-connection rail control circuit 304 can turn on the enable signal at rail enable node 314 first, before any other enable signals are turned on; and can turn off the enable signal at node 314 last, after any other enable signals are turned off, e.g., by using an internal delay timer of the voltage regulator (or other component) as described above.

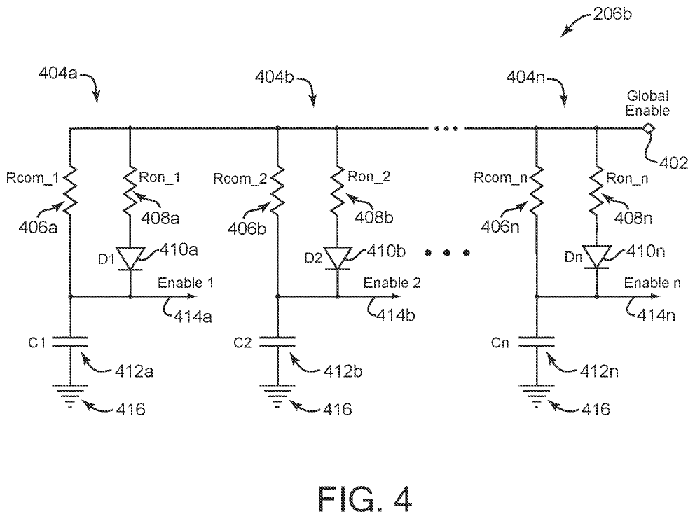

FIG. 4 is a schematic illustration of another example power sequence control circuit 206b, according to some implementations. Control circuit 206b provides enable signals that can be used to turn on and off voltage rail signals provided to a target electronic component according to particular sequencing and/or timing requirements. In some examples, power sequence control circuit 206b can be, or can be included in, power sequence control circuit 206 of system 200 of FIG. 2, and can be used to control the power rail voltages provided to a target electronic component such as codec 212 in the example of FIG. 2 or other type of electronic component.

Control circuit 206b can similarly provide enable signals to voltage regulators as described above for control circuit 206a. Control circuit 206b provides parallel resistances for RC time constants when the global enable signal turns on, rather than providing such parallel resistances when the global enable signal turns off as in circuit 206a.

Control circuit 206b includes a global enable node 402 that can receive a global enable signal similarly as global enable node 302. Control circuit 206b includes multiple rail control circuits 404, where each rail control circuit 404 provides a respective power rail enable signal to a respective voltage regulator (or other component) to control a supply voltage output by that regulator, e.g., control circuits 404a, 404b, up to 404n providing respective power rail enable signals Enable 1, Enable 2, up to Enable n.

In some implementations, e.g., a general case, each rail control circuit 404 can include a common resistor 406, a power-off resistor 408, a diode 410, and a capacitor 412. Common resistor 406 has a resistance value Rcom and is coupled between global enable node 402 and a rail enable node 414. Power-on resistor 408 has a resistance value Ron and is coupled to the global enable node. Diode 410 is coupled between the power-on resistor 408 and the rail enable node 414. Diode 410 has a forward conducting direction away from global enable node 402 and the power-on resistor 408, and toward the rail enable node 414, and thus is oriented in the opposite conducting direction of diode 310 of control circuit 206a. Capacitor 412 is coupled between rail enable node 414 and electrical ground 416.

In some implementations, each rail control circuit 404 has properties including a first RC characteristic when global enable signal 402 is turned on and a second RC characteristic when global enable signal 402 is turned off. Common resistor 406 influences rail enable node 414 when the global enable signal on node 402 turns on and also when that signal turns off, and power-on resistor 408 influences rail enable node 414 when the global enable signal on node 402 turns on.

The properties of the resistors 406 and 408 (resistance values) and/or the capacitor 412 (capacitance value) are selected to obtain required timing of the enable signals at rail enable nodes 414. The RC time constants can be selected to provide a particular timing for the enable signal to reach particular voltage levels.

In an example of turning on supply rail voltages in response to the global enable signal being turned on, two rail control circuits 404a and 404b are used and the enable signal Enable 1 is to be turned on before the enable signal Enable 2 is to be turned on. The RC time constant of control circuit 404a is made smaller than the RC time constant of control circuit 404b for current flowing from the global enable node 402 to the rail enable nodes 414a and 414b.

The turn-on path in each circuit 404 is resistor 406 in parallel with resistor 408 to charge capacitor 412. In this example, the resistance values Rcom_1, Rcom_2, Roff_1, and Roff_2 and capacitance values C1 and C2 can be selected such that the RC time constant of rail control circuit 404a is smaller than the RC time constant of rail control circuit 404b for current flowing from the global enable node 402 rail enable node 414. For control circuit 404a, the RC time constant is the product of (Rcom_1∥Ron_1) and the capacitance C1. For control circuit 304b, the RC time constant is the product of (Rcom_2∥Ron_2) and the capacitance C2.

When the global enable signal 402 is turned on (enabled), diodes 410a and 410b conduct current, which allows the parallel resistance of resistors 406a/408a and 406b/408b to contribute to the RC time constant. The resistance of the RC time constant is based on the parallel configuration of resistors 406 and 408 (the parallel resistance is influenced by the resistor 408, unlike in the turn off case). Thus, when the RC time constant of rail control circuit 304a is smaller than the RC time constant for rail control circuit 304b, the delay for turning on the Enable 1 signal at the rail enable node 314a is smaller than for turning off the Enable 2 signal at the rail enable node 314b, and Enable 1 is turned on faster than Enable 2.

In an example of turning off supply rail voltages in response to the global enable signal being turned off, two rail control circuits 304a and 304b are used and the enable signal Enable 2 is to be turned off before the enable signal Enable 1. The RC time constant of control circuit 304b is made smaller than the RC time constant of control circuit 304a for current flowing from the rail enable nodes 314a and 314b to the global enable node 302. The turn-off path in each circuit 404 is resistor 406 that discharges capacitor 412.

In some examples, the RC time constant of rail control circuit 404b (based on the product of resistance Rcom_2 of resistor 406b and capacitance C2 of capacitor 412b) can be smaller than the RC time constant of rail control circuit 404a (based on the product of resistance Rcom_1 of resistor 406a and capacitance C1 of capacitor 412a). When the global enable signal 402 is turned off (disabled), diodes 410a and 410b do not conduct current, which prevents resistors 408a and 408b from contributing to the RC time constant. The smaller RC time constant of circuit 404b causes the delay for turning off the Enable 2 signal at the rail enable node 314b to be smaller than the delay for turning off the Enable 1 signal at the rail enable node 314a, and Enable 2 is turned off faster than Enable 1. The resistance values of resistors 406a and 406b and the capacitance values of capacitors 412a and 412b can be selected such that the enable signals turn on at times that meet the power-on sequencing requirement (such as the example timing requirement for voltage rail signals 102 and 112 of FIG. 1).

In implementations that use more than two rail control circuits and enable signals (e.g., including rail control circuit 404n and Enable n), the properties of the resistors and/or capacitors in each circuit 404 can be selected, relative to the properties of these components in each other circuit 404, to provide appropriate RC time constants to meet sequencing and/or timing requirements for the enable signals, e.g., in a similar way as described for circuit 206a. In some implementations, one or more resistors and/or one or more capacitors of one or more rail control circuits 404 can be shorted connections, e.g., their properties (resistances or capacitances) set to zero or very small values, similarly as described above for circuit 206a. For example, common resistor 406 of one of the rail control circuits 404 may have zero resistance (e.g., may be omitted such that there is a direct connection), which causes the enable signal at the associated rail enable node 414 to drop at the same rate as the global enable signal 302 turning off. For example, such a resistor 406 (or omission of resistor 406) can be provided in a rail control circuit 404 that turns off a power rail before any other power rail being controlled by circuit 206b.

In some implementations, the power-on resistor 408 of one of the rail control circuits 404 may have zero resistance (e.g., may be omitted such that there is a direct connection from diode 410 of that rail control circuit to global enable node 402). Resistor 408 having zero resistance can cause the associated rail enable node 414 to turn on at the same rate as the global enable signal 402 through diode 410. For example, such a resistor 408 (or omission of resistor 408) can be provided in a rail control circuit 404 that turns on a power rail before any other power rail being controlled by circuit 206b.

In some implementations, resistor 406 of one of the rail control circuits 404 may have zero resistance (e.g., may be omitted and replaced with direct connection similarly as above), but the associated rail enable node 414 can turn off at a delayed time, e.g., after one or more other rail control circuits 404 are turned off. For example, the voltage regulator controlled by the circuit 404 may be a DVFS voltage regulator (or other type of voltage regulator) that includes an internal delay timer that can delay the turning off and discharge of its supplied power. In some implementations, one of the rail control circuits 404 may have none of the resistor 406, resistor 408, and capacitor 412, e.g., similarly as described above for control circuit 206a.

In some implementations, variable resistors (whose resistance values can be configured on-device after the device is shipped) can be provided for resistors 306 and/or resistors 308, and/or variable capacitors (whose capacitance values can be configured on-device after the device is shipped) can be provided for capacitors 312, to allow the resistances and/or capacitances to be easily changed. This allows power sequence control circuit 206a to be tuned or modified to provide different enable signal timings to meet different power sequencing and timing requirements. Similar variable resistors and/or variable capacitors can be used for components of circuit 206b.

Although the description has been described with respect to particular implementations thereof, these particular implementations are merely illustrative, and not restrictive. Concepts illustrated in the examples may be applied to other examples and implementations. Note that the functional blocks, operations, features, methods, devices, and systems described in the present disclosure may be integrated or divided into different combinations of systems, devices, and functional blocks as would be known to those skilled in the art.

1. A power sequence control circuit comprising:
a global enable node;
a first rail control circuit coupled to the global enable node, the first rail control circuit having one or more first resistor-capacitor (RC) characteristics;
a first rail enable node coupled to the first rail control circuit and to a first voltage regulator;
a second rail control circuit coupled to the global enable node, the second rail control circuit having one or more second RC characteristics that are different than the one or more first RC characteristics; and
a second rail enable node coupled to the second rail control circuit and to a second voltage regulator,
wherein turning on a global enable signal on the global enable node causes a first enable signal on the first rail enable node to be turned on before a second enable signal on the second rail enable node is turned on, thereby causing the first voltage regulator to turn on before the second voltage regulator is turned on, and
wherein turning off the global enable signal on the global enable node causes the second enable signal on the second rail enable signal to be turned off before the first enable signal on the first rail enable node is turned off, thereby causing the second voltage regulator to turn off before the first voltage regulator is turned off.

2. The power sequence control circuit of claim 1, wherein:
the one or more first RC characteristics include a first power-on RC characteristic that is applied when the global enable signal is turned on, and a second power-off RC characteristic that is applied with the global enable signal is turned off, and
the one or more second RC characteristics include a third power-on RC characteristic that is applied when the global enable signal is turned on, and a fourth power-off RC characteristic that is applied with the global enable signal is turned off.

3. The power sequence control circuit of claim 1, wherein:
the first rail control circuit includes:
a first resistor that has a first resistance value and is coupled between the global enable node and the first rail enable node;
a second resistor that has a second resistance value and is coupled to the global enable node;
a first diode coupled between the second resistor and the first rail enable node; and
a first capacitor coupled between the first rail enable node and a ground; and
the second rail control circuit includes:
a third resistor that has a third resistance value and is coupled between the global enable node and the second rail enable node;
a fourth resistor that has a fourth resistance value and is coupled to the global enable node;
a second diode coupled between the fourth resistor and the second enable signal; and
a second capacitor coupled between the second rail enable signal and the ground,
wherein the first enable signal on the first rail enable node is turned on, based on a first power-on RC time constant of the first rail control circuit, before the second enable signal on the second rail enable node is turned on based on a second power-on RC time constant of the second rail control circuit, and
wherein the second enable signal on the second rail enable node is turned off, based on a second power-off RC time constant of the second rail control circuit, before the first enable signal on the first rail enable node is turned off based on a first power-off RC time constant of the first rail control circuit.

4. The power sequence control circuit of claim 3, wherein the timing of the turning off of the first enable signal is based on the first resistance value in parallel with the second resistance value as the first diode conducts in response to the turning off of the global enable signal, and the timing of the turning off of the second enable signal is based on the third resistance value in parallel with the fourth resistance value as the second diode conducts in response to the turning off of the global enable signal.

5. The power sequence control circuit of claim 3, wherein the first diode and the second diode are configured to conduct in a direction toward the global enable node.

6. The power sequence control circuit of claim 3, wherein the first diode and the second diode are configured to conduct in a direction away from global enable node.

7. The power sequence control circuit of claim 1, wherein:
the first rail control circuit includes:
a connection between the global enable node and the first rail enable node;
a first resistor that has a first resistance value and is coupled to the global enable node;
a first diode coupled between the first resistor and the first rail enable node; and
a first capacitor coupled between the first rail enable node and a ground; and
the second rail control circuit includes:
a second resistor that has a second resistance value and is coupled between the global enable node and the second rail enable node;
a second diode coupled between global enable node and the second rail enable node; and
a second capacitor coupled between the second rail enable node and the ground,
wherein the first enable signal on the first rail enable node is turned on, based on a first power-on RC time constant of the first rail control circuit, before the second enable signal on the second rail enable node is turned on based on a second power-on RC time constant of the second rail control circuit, and
wherein the second enable signal on the second rail enable node is turned off, based on a second power-off RC time constant of the second rail control circuit, before the first enable signal on the first rail enable node is turned off based on a first power-off RC time constant of the first rail control circuit.

8. The power sequence control circuit of claim 7, wherein a resistance of the connection between the global enable node and the first rail enable node is lower than the second resistance value, and wherein a resistance of a connection between the global enable node and the second rail enable node via the second diode is lower than the first resistance value.

9. The power sequence control circuit of claim 1, wherein the first voltage regulator outputs a first operating voltage and the second voltage regulator outputs a second operating voltage, wherein the first operating voltage is lower than the second operating voltage.

10. The power sequence control circuit of claim 1, further comprising:
a third rail control circuit coupled to the global enable node and having a third resistor-capacitor (RC) characteristic; and
a third rail enable node coupled to the third rail control circuit, wherein a third voltage regulator is coupled to the third rail enable node,
wherein turning on the global enable signal on the global enable node causes a third rail enable signal to be turned on after the first rail enable signal and the second rail enable signal are turned on, thereby causing the third voltage regulator to turn on after the first voltage regulator and the second voltage regulator are turned on, and
wherein turning off the global enable signal on the global enable node causes the third rail enable signal to be turned off before the first rail enable signal and the second rail enable signal are turned off, thereby causing the third voltage regulator to turn off before the first voltage regulator and the second voltage regulator are turned off.

11. The power sequence control circuit of claim 10, wherein the first voltage regulator outputs a first operating voltage, the second voltage regulator outputs a second operating voltage, and the third voltage regulator outputs a third operating voltage, wherein the first operating voltage is lower than the second operating voltage, and the second operating voltage is lower than the third operating voltage.

12. The power sequence control circuit of claim 1, wherein the first voltage regulator and the second voltage regulator are coupled to an electronic component on an integrated circuit and provide power to the electronic component.

13. The power sequence control circuit of claim 1, wherein the first rail control circuit and the second rail control circuit are passive and do not require power to operate.

14. A power sequence control circuit comprising:
a global enable node;
a first rail enable node coupled to the global enable node and to a first voltage regulator;
a rail control circuit coupled to the global enable node, the rail control circuit having a resistor-capacitor (RC) characteristic; and
a second rail enable node coupled to the rail control circuit and to a second voltage regulator,
wherein turning on a global enable signal on the global enable node causes a first enable signal on the first rail enable node to be turned on before a second enable signal on the second rail enable node is turned on, thereby causing the first voltage regulator to turn on before the second voltage regulator in turned on, and
wherein turning off the global enable signal on the global enable node causes the second enable signal on the second rail enable signal to be turned off before the first enable signal on the first rail enable node is turned off, thereby causing the second voltage regulator to turn off before the first voltage regulator is turned off.
